(19) United States
(12) Patent Application Publication
(10) Pub. No.: US 2011/0257834 A1
(43) Pub. Date: Oct. 20, 2011

(54) Mobile Data Loader for Aircraft Wireless Data Communications

(75) Inventor: Gary Marshall Hebb, Ottawa (CA)

(73) Assignee: EMS Technologies, Inc.

(21) Appl. No.: 13/087,666

(22) Filed: Apr. 15, 2011

Related U.S. Application Data
(60) Provisional application No. 61/324,510, filed on Apr. 15, 2010.

(51) Int. Cl. G06F 19/00

(52) U.S. Cl. 701/33

(57) ABSTRACT

Systems and methods for transferring data between a computer located on an aircraft and a computer located at an airport facility, such as at an airport gate or terminal, catering facility, baggage depot, or fueling depot, are described herein. The facility computer can store data content destined for aircraft that are to be serviced by the facility. A computer installed on a vehicle, such as a utility or catering truck can transfer data wirelessly with the facility computer and with the aircraft computer. An operator can navigate the vehicle between the facility and the aircraft to transfer data between the aircraft computer and the facility computer. Each of the computers can be communicably coupled to a wireless communication module to facilitate the wireless data transfer. The wireless communication modules can operate at a frequency range of approximately 60 GHz to facilitate quick transfer of large amounts of data.

### RELATED PATENT APPLICATION

This non-provisional patent application claims priority under 35 U.S.C. §119 to U.S. Provisional Patent Application No. 61/324,510, entitled, “Mobile Data Loader for Aircraft Wireless Data Communications,” filed Apr. 15, 2010, the entire contents of which are hereby fully incorporated herein by reference.

### TECHNICAL FIELD

The present disclosure relates generally to transferring data onto and off of an aircraft and, more specifically, to systems and methods for transferring data between a computer located at an airport facility and a computer located at an aircraft.

### BACKGROUND

Data is often loaded onto and off of commercial aircraft while the aircraft is parked at an airport terminal or gate. For example, flight specific data and aircraft performance and maintenance data may be offloaded for use by an airline at the conclusion of a flight. Also, in-flight entertainment content, such as movies, music, and games, is often loaded onto passenger aircraft prior to a flight. Conventionally, this data is transferred between the aircraft and another storage location via a memory storage device, such as a DVD/CD-RW, removable hard disk drive, memory stick, flash disk, or magnetic tape. That is, an operator physically transfers a memory storage device between a computer located on the ground and a computer located on the aircraft.

Wireless communication technologies, such as Wi-Fi and mobile telecommunication protocols, have not been widely adopted today for aircraft communications, particularly at airport terminals or gates, for several reasons. By way of example, a wide scale adoption of conventional Wi-Fi or mobile telecommunication technologies at airport installations is limited by expenses arising from installation of wireless communication equipment at each airport gate to support direct communication between the gate and an aircraft. Furthermore, these communication technologies support data rates that are too slow to communicate significant data volume. For example, loading movies onto an aircraft via Wi-Fi may take hours. Other users of these popular communication technologies, such as passengers in airport terminals, can generate interference that would interrupt or contend with the gate/aircraft communication link. Moreover, gate-based equipment installation does not support wireless communication with aircraft that taxi to a location other than an airport gate for aircraft servicing or loading and unloading of passengers or cargo.

### SUMMARY

The present invention provides systems and methods for transferring data between a computer located on an aircraft and a computer located at an airport facility, such as at an airport gate or terminal, catering facility, baggage depot, or fueling depot. The facility computer can receive and store data content destined for aircraft that are to be serviced by the facility. Another computer having bulk storage capabilities can be installed on a vehicle, such as a catering truck, baggage truck, fueling truck, or dedicated utility vehicle. The vehicle also can have a high speed wireless communication module that can communicate with a wireless communication module communicably coupled to the aircraft computer and with a wireless communication module communicably coupled to the facility computer. In certain exemplary embodiments, each of the aforementioned wireless communication modules operate at a frequency range of approximately 60 GHz to support quick wireless transfer of large amounts of data.

The vehicle computer can transfer data between the aircraft computer and the facility computer. An operator can position the vehicle such that the vehicle's wireless communication module can establish a communication link with the facility's wireless communication module. Once the communication link is established, the vehicle computer can exchange data with the facility computer. For example, the vehicle computer may transmit flight data, aircraft performance data, maintenance information, log files, including video log files, and in-flight entertainment usage and billing information received from an aircraft to the facility computer and receive in-flight entertainment content from the facility computer. The operator also can position the vehicle near one or more aircraft such that the vehicle's wireless communication module can establish a communication link with the aircraft's wireless communication module. Once the communication link is established, the vehicle computer can exchange data with the aircraft computer. For example, the vehicle computer may transmit in-flight entertainment content to the aircraft computer and receive flight data, aircraft performance data, maintenance information, log files, including video log files, and in-flight entertainment usage and billing information from the aircraft computer.

In one embodiment, a method for transferring data between a computer located on an aircraft and a computer located at a facility includes a computer located on a ground mobile vehicle receiving data from the computer located at the facility via a wireless communication link between the computer located at the facility and the computer located on the vehicle. The vehicle can be moved from a position near the facility to a position near the aircraft. The data can be transferred from the computer located on the vehicle to the computer located on the aircraft via a wireless communication link between the computer located on the vehicle and the computer located on the aircraft.

In another embodiment, a method for transferring data between a computer located on an aircraft and a computer located at a facility includes a computer located on a ground mobile vehicle receiving data from the computer located at the aircraft via a wireless communication link between the computer located at the aircraft and the computer located on the vehicle. The vehicle can be moved from a position near the aircraft to a position near the facility. The data can be transmitted from the computer located on the vehicle to the computer located at the facility via a wireless communication link between the computer located on the vehicle and the computer located at the facility.

In yet another embodiment, a system for transferring data can include a first computer located at an airport facility that stores data for one or more aircraft. The first computer being communicably coupled to a first wireless communication module. At least one vehicle can include a second computer that transfers the data between the first computer and a third computer installed on each of the one or more aircraft. The second computer can be communicably coupled to a second wireless communication module configured to exchange data with the first wireless communication module and to exchange data with a third wireless communication module communicably coupled to the third computer.

These and other aspects, objects, features, and advantages of the exemplary embodiments will become apparent to those having ordinary skill in the art upon consideration of the following detailed description of illustrated exemplary embodiments, which include the best mode of carrying out the invention as presently perceived.

### BRIEF DESCRIPTION OF THE DRAWINGS

FIG. 1 is a block diagram depicting an operating environment, in accordance with certain exemplary embodiments.

FIG. 2 is a block flow diagram depicting a method for transferring data between an airport facility and a mobile vehicle, in accordance with certain exemplary embodiments.

FIG. 3 is a block flow diagram depicting a method for transferring data between a mobile vehicle and an aircraft, in accordance with certain exemplary embodiments.

### DETAILED DESCRIPTION OF EXEMPLARY EMBODIMENTS

The methods and systems described herein facilitate the transfer of data between a computer installed on an aircraft and another computer, such as a computer installed at an airport facility. An exemplary system includes at least one vehicle having a computer located thereon. The vehicle computer includes or is communicably coupled to a wireless communication module for exchanging data with the aircraft computer and for exchanging data with the facility computer. Throughout the discussion of the exemplary embodiments, it should be understood that the terms “data” and “information” are used interchangeably herein to refer to text, documents, images, audio, video, games, log files, or any other form of information that an exist in a computer-based environment.

An operator can navigate the vehicle into a position at or near the facility such that the wireless communication module of the vehicle can communicate with a wireless communication module of the facility computer to enable data transfer between the vehicle computer and the facility computer. Similarly, the operator can navigate the vehicle into a position at or near the aircraft such that the wireless communication module of the vehicle can communicate with wireless communication module of the aircraft to enable data transfer between the vehicle computer and the aircraft computer. Thus, the vehicle computer can transfer data between the aircraft and the facility. For example, the vehicle computer can transfer flight data, aircraft performance data, maintenance information, log files, including video log files, and in-flight entertainment usage and billing information from the aircraft computer to the facility computer for consumption by an airline. The vehicle computer also can transfer in-flight entertainment content or other content from the facility computer to the aircraft computer. This system and method allows for a single (or more) access point located at an airport to service many aircraft, whether the aircraft are parked at a gate, parked on a runway apron, being serviced in a maintenance hangar, or located elsewhere.

The vehicle computer can be installed on a vehicle that normally services aircraft. In this way, the vehicle can complete the data transfers while receiving and/or delivering its normal payload. For example, a catering truck can carry a computer that exchanges data with a computer located at a catering facility at the airport while an operator loads food and drinks onto the truck for an aircraft. The catering truck computer also can exchange data with a computer located onboard an aircraft while the operator is delivering the food and drinks onto the aircraft.

In certain exemplary embodiments, the vehicle computer can exchange data automatically with the aircraft computer and the facility computer without operator intervention. For example, the wireless module of the vehicle computer can detect the wireless module of the aircraft computer and automatically begin the data exchange in response to detecting the wireless module of the aircraft computer. Similarly, the wireless module of the vehicle computer can detect the wireless module of the facility computer and automatically begin the data exchange in response to detecting the wireless module of the facility computer. In this way, operator training and operator intervention is minimized or eliminated.

In certain exemplary embodiments, an operator at an airline or other content provider provides data content at the facility computer for one or more aircraft. The operator can identify the aircraft that the data content is for by associating an aircraft identifier with the data content. Each of a multitude of vehicle computers can obtain all or a certain portion of the data content and the associated aircraft identifier(s) from the facility computer via a wireless communication link while the vehicles are at the facility. An operator can navigate the vehicle to each aircraft. While the vehicle is within wireless communication range with the vehicle computer, the vehicle computer can exchange data with the aircraft computer via a wireless communication link. To ensure that the proper data is loaded onto the aircraft computer, the aircraft computer can transmit an aircraft identifier that identifies the aircraft to the vehicle computer and the vehicle computer can use the aircraft identifier to determine what data content to provide to the aircraft computer. Alternatively, the operator can input an aircraft identifier into the vehicle computer manually and the vehicle computer can use the manually entered aircraft identifier to determine what data to transmit to the aircraft computer.

One or more aspects of the invention may include a computer program that embodies the functions described and illustrated herein, wherein the computer program is implemented in a computer system that includes instructions stored in a machine-readable medium and a processor that executes the instructions. However, it should be apparent that there could be many different ways of implementing the invention in computer programming, and the invention should not be construed as limited to any one set of computer program instructions. Further, a skilled programmer would be able to write such a computer program to implement an embodiment of the disclosed invention based on the appended flow charts and associated description in the application text. Therefore, disclosure of a particular set of program code instructions is not considered necessary for an adequate understanding of how to make and use the invention. Further, those skilled in the art will appreciate that one or more aspects of the invention described herein may be performed by hardware, software, or a combination thereof, as may be embodied in one or more computing systems. Moreover, any reference to an act being performed by a computer should not be construed as being performed by a single computer as the act may be performed by more than one computer. The inventive functionality of the invention will be explained in more detail in the following description, read in conjunction with the figures illustrating the program flow.

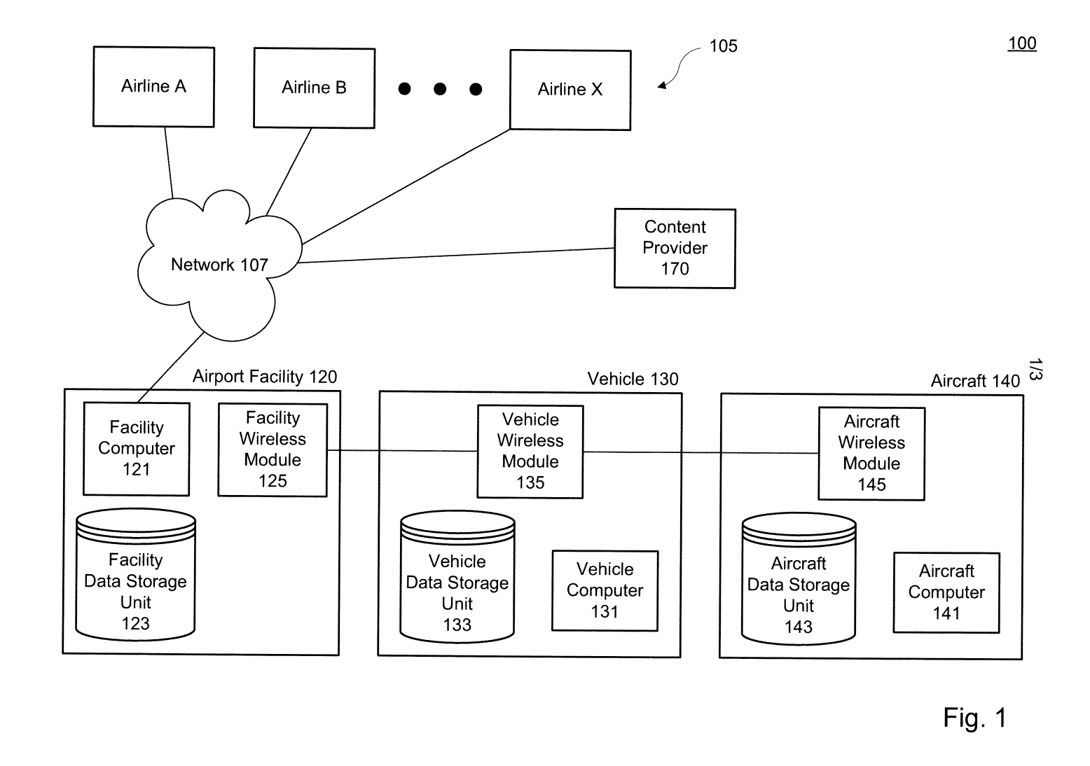

Turning now to the drawings, in which like numerals indicate like elements throughout the figures, exemplary embodiments of the invention are described in detail. FIG. 1 is a block diagram depicting an operating environment 100, in accordance with certain exemplary embodiments. As depicted in FIG. 1, the exemplary operating environment 100 includes an airport facility 120. The airport facility 120 may be an airport gate or terminal, catering facility, baggage depot, fueling depot, in-flight magazine depot, maintenance hangar, cargo depot, airline office building, or some other facility located at or near an airport or some other location.

The airport facility 120 includes a computer 121, a data storage unit 123, and a wireless communication module 125. The facility computer 121 may be a server, desktop computer, laptop computer, or any other type of computing device. The facility computer 121 includes or is communicably coupled to the facility data storage unit 123 and the facility wireless communication module 125. The facility data storage unit 123 can include a hard disk drive, flash memory, network-attached storage, or other type of computer data storage device.

The facility computer 121 is configured to transmit and receive data over a network 107. For example, the network 107 can include a local area network (“LAN”), a wide area network (“WAN”), an intranet, an Internet, or any combination thereof. Also connected to the network 107 are network devices of one or more airlines 105 and a content provider 170. For example, each airline 105 and the content provider 170 may have a server, desktop computer, laptop computer, or other processor-driven device capable of communicating with other devices, including the facility computer 121, via the network 107.

In certain exemplary embodiments, the facility wireless communication module 125 includes a 60 GHz point to multipoint wireless access point. The use of 60 GHz wireless technology vastly increases the rate at which data can be transferred between compatible devices compared to conventional Wi-Fi and mobile telecommunication technologies, such as third generation (“3G”) and fourth generation (“4G”) mobile telecommunication technologies. The 60 GHz communications band represents an unlicensed frequency band, and the largest frequency band currently allocated for communications usage by the Federal Communications Commission (“FCC”) in the U.S., with 7 GHz of spectrum. Because portions of this communications band are available around the world, wireless communication devices operating in the 60 GHz range may be configured to use frequency allocation that is supported in the device's operating location. The 60 GHz communication band is particularly useful for wireless communications in an airport environment because of the availability around the world and further because wireless signals in the 60 GHz range are absorbed by oxygen and travel a short distance only before being severely attenuated. Also, compact highly directive antennas can be used with a transmitter and receiver operating at the 60 GHz range. These features improve the signal-to-noise ratio for communications, to ensure a high data rate, error free transmission, reduce potential interference from other 60 GHz communication systems, and further reduce the opportunity for an unauthorized receiver to illegally intercept data.

Other devices having a compatible wireless communication module can access the facility computer 121 and the facility data storage unit 123 via the facility wireless communication module 125. For example, one or more vehicles 130 can include a wireless communication module 135 for communicating with the facility computer 121 via the facility wireless communication module 125. Each vehicle 130 also includes a computer 131 and a data storage unit 133 for transferring data between the facility computer 121 and computers 141 installed on one or more aircrafts 140. Each aircraft 140 also includes a wireless communication module 145 and a data storage unit 143. Similar to the facility data storage unit 123, the vehicle data storage unit 133 and the aircraft data storage unit 143 each can include a hard disk drive, flash memory, network-attached storage, or other type of computer data storage device. Likewise, the computers 131, 141 can each include a server, desktop computer, laptop computer, tablet computer, or any other type of computing device.

In certain exemplary embodiments, each of the wireless communication modules 125, 135, 145 communicate via the 60 GHz frequency band. For example, the facility wireless communication module 125 may include a 60 GHz point to multipoint wireless access point and the wireless communication modules 135, 145 may each include a 60 GHz point to point radio. In certain exemplary embodiments, the vehicle wireless communication module 135 includes a 60 GHz wireless access point, for example to communicate with more than one aircraft wireless communication module 145 at a time.

Other wireless technologies also can be used in place of or in addition to 60 GHz wireless. For example, Bluetooth, infrared wireless, ultra-wideband (“UWB”), Wi-Fi, or a mobile telecommunication technology may be used in certain exemplary embodiments. However, the 60 GHz wireless provides higher bandwidth than the aforementioned technologies and is better suited for transferring large amount of data, such as movies and games for in-flight entertainment, in a short amount of time, such as while an aircraft is being serviced by a catering truck, being fueled, or while the aircraft is waiting at a gate. For smaller data loads or longer time periods for transferring data, one of the alternative wireless communication technologies may be suitable.

The vehicles 130 are used to transfer data between the facility 120 (and ultimately the airlines 105) and the aircraft 140. For example, one of the vehicles 130 may transfer in-flight entertainment content, software upgrades for on-board avionics computers, passenger lists, baggage information, and other flight information from an airline 105 to an aircraft 140 prior to a flight via the facility computer 121. In another example, one of the vehicles 130 may transfer flight data, aircraft performance data, maintenance information, log files, including video log files, and in-flight entertainment usage and billing information from an aircraft 140 to an airline 105 via the facility computer 121 at the conclusion of a flight.

In certain exemplary embodiments, the vehicles 130 are associated with a facility 120 that services aircraft between each flight. For example, the facility 120 may be a catering facility that provides in-flight food and drinks for passenger aircraft 140. In this example, the vehicles 130 may be catering trucks that are navigated between the catering facility 120 where the food and drinks are stored and aircraft 140. While the vehicle 130 is located at the facility 120 to load food and drinks, the vehicle computer 131 can exchange data with the facility computer 121 via the wireless communication modules 125, 135. Similarly, while the vehicle 130 is located near the aircraft 140 to load the drinks and food, the vehicle computer 131 can exchange data with the aircraft computer 141 via the wireless communication modules 135, 145.

In another example, aircraft fueling vehicles may be used to transfer data between the facility computer 121 and the aircraft computer 141. In this example, the facility computer 121 may be located at a fueling depot of an airport. In yet another example, baggage carrying trucks may be used to transfer data between the facility computer 121 and the aircraft computer 141. In this example, the facility computer 121 may be located at a baggage depot of an airport.

In certain exemplary embodiments, the vehicles 130 are dedicated to transferring data between one or more airlines 150 and the aircraft 140 of those airlines 105. In such an embodiment, the facility 120 may be a hangar or other facility 120 operated by the airline 105 where the facility computer 121 and facility wireless communication module 125 can be installed. The vehicles 130 may be utility trucks dedicated to transferring data between the airlines 105 and the aircraft 140. The vehicles 130 may visit each aircraft 140 between flights to transfer data. Regardless of where the facility 120 and the facility computer 121 are located, the facility computer 121 is communicably coupled to the network 107 for access by one or more airlines 105 and the content provider 170.

Antennas of the wireless communication modules 125, 135, 145 can be installed in locations at the facility 120, the vehicle 130, and the aircraft 140, respectively, to support line of sight wireless communication. For example, an antenna coupled to the facility wireless communication module 125 (“facility antenna”) may be located outside the facility 120, at a loading dock of the facility 120, at a window of the facility 120, or at another location such that an antenna coupled to the vehicle wireless communication module 135 (“vehicle antenna”) has a line of sight to the facility antenna.

The vehicle antenna also can be positioned on the vehicle 130 to support line of sight communication with the facility antenna and to further support line of sight communication with an antenna coupled to the aircraft wireless communication module 145 (“aircraft antenna”). For example, the vehicle antenna may be installed on the rear of a truck where cargo is loaded an unloaded such that the vehicle antenna is directed at a facility antenna located at the loading dock. Alternatively, the vehicle antenna may be installed at the front of the truck and the facility antenna may be installed in a position where there is a line of sight to the front of the truck and thus, the vehicle antenna. The aircraft antenna may be installed in a window of the aircraft or in a cargo bay of the aircraft to have a line of sight to a vehicle antenna installed on a vehicle 130 that services the aircraft 140 near the window or cargo bay.

In a catering truck embodiment or other truck embodiment having a lifting mechanism, such as a lifting box portion, the vehicle antenna may be installed on the lifted portion of the truck such that the vehicle antenna is also lifted when the aircraft 140 is being serviced by the truck. As aircraft computers 141 for in-flight entertainment are often located at the rear of plane where food and drinks are often loaded onto the aircraft 140, the aircraft antenna can be located near the aircraft door where the food and drinks are located. In this location, the aircraft antenna and vehicle antenna have a direct line of sight without obstruction when the aircraft 140 is being serviced.

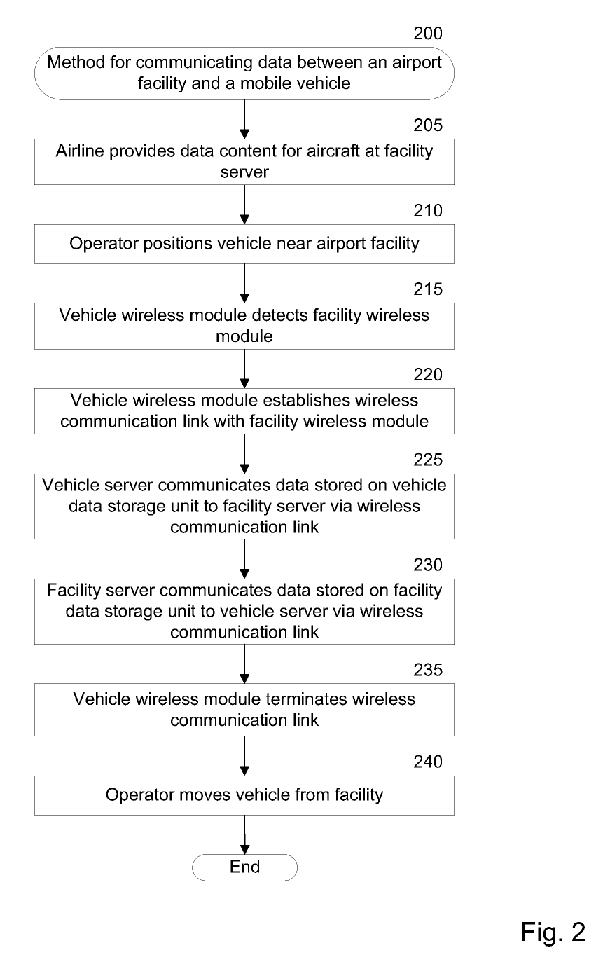

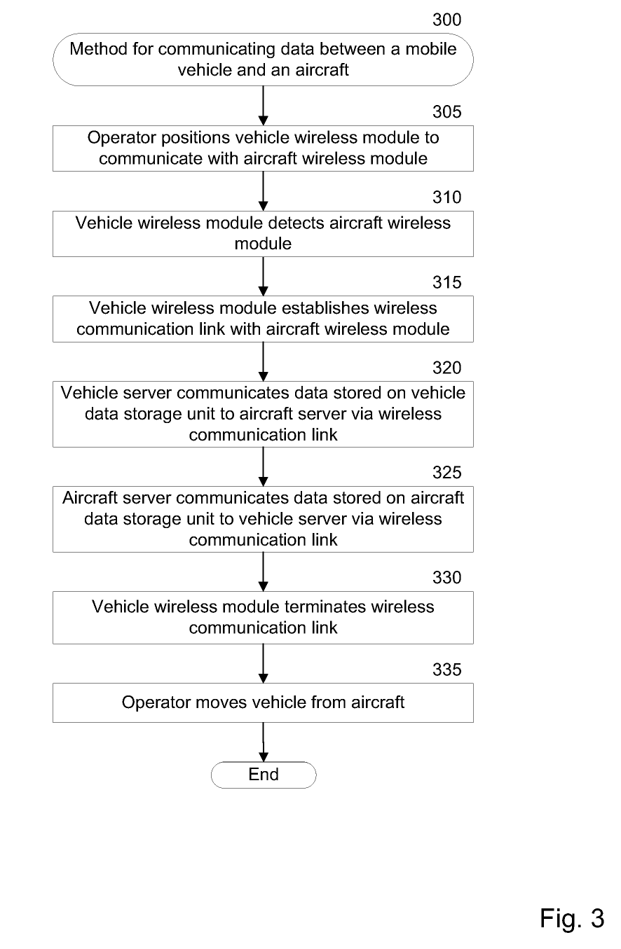

The components of the operating environment 100 are described in more detail hereinafter with reference to the methods illustrated in FIGS. 2 and 3. FIG. 2 is a block flow diagram depicting a method 200 for transferring data between the airport facility 120 and the vehicle 130, in accordance with certain exemplary embodiments. The method 200 is described with reference to the components illustrated in FIG. 1.

In block 205, an airline 105 provides data content for an aircraft 140 at the facility computer 121. For example, an airline 105 may provide certain in-flight entertainment content, software upgrades for on-board avionics computers, a passenger list, information regarding luggage aboard the aircraft, and/or flight information for an aircraft 140 that is to be serviced by the facility 120 prior to a flight. In addition to or in the alternative, the content provider 170 provides content for the aircraft 140 at the facility computer 121. For example, the content provider 170 may provide the in-flight entertainment content for an airline 105 directly to the facility computer 121. Regardless of who provides the data content, the facility computer 121 receives the data content via the network 107 and stores the content in the facility data storage unit 123.

The airline 105 may specify which aircraft 140 the data is destined for. For example, the airline 105 may associate the data with an aircraft identifier that identifies the aircraft 140. By having the aircraft identifier, the data can be transferred to the appropriate aircraft 140, as described in further detail below.

In block 210, a vehicle operator navigates one of the vehicles 130 to the facility 120 where the facility computer 121 is located. For example, a catering truck operator may navigate a catering truck having a vehicle computer 131 to a catering facility to receive food and drinks for the aircraft 140.

In block 215, the vehicle wireless communication module 135 detects the facility wireless communication module 125. In block 220, the vehicle wireless module 135 establishes a wireless communication link with the facility wireless module 125. This wireless communication link may be established automatically in response to the vehicle wireless module 135 detecting the facility wireless communication module 125. Alternatively, the facility wireless communication module 125 may detect the vehicle wireless communication module 135 and establish the wireless communication link automatically in response thereto.

The vehicle computer 131 and the facility computer 121 may identify themselves to one another when the wireless communication link is initialized. For example, the vehicle computer 131 may transmit information identifying the vehicle 130 or the vehicle computer 131 to the facility computer 121 via the wireless communication link. Likewise, the facility computer 121 may transmit identifying the facility 120 or the facility computer 121 to the vehicle computer 131 via the wireless communication link. This identifying information may be used to determine what data is exchanged between the vehicle computer 131 and the facility computer 131. For example, certain vehicles 130 may serve certain aircraft 140 and thus, the facility computer 121 may transfer data to the vehicle computer 131 for those aircraft 140 only. The facility computer 121 can use the aircraft identifier associated with the data and the information identifying the vehicle 130 to determine what data to transmit to the vehicle computer 131. Or, the facility computer 121 may transfer data for all aircraft 140 to each vehicle computer 131 and let the vehicle computer 131 transfer the appropriate data to the appropriate aircraft 140 based on the aircraft identifier associated with the data. The information identifying the facility 120 and the information identifying the vehicle 130 also may be used for security purposes to ensure that each computer 121, 131 is communicating with an appropriate device.

In block 225, the vehicle computer 131 communicates data stored at the vehicle data storage unit 133 to the facility computer 121 via the established wireless communication link. For example, the vehicle computer 131 may communicate flight data, aircraft performance data, maintenance information, and in-flight entertainment usage and billing information received from one or more aircraft 140 to the facility computer 121 via the established wireless communication link. Once received, the facility computer 121 stores the received data in the data storage unit 123. Airlines 105 associated with the received information can then access the facility computer 121 via the network 107 to view or retrieve the received information. For example, each airline 105 may have an account with the facility 120 to provide and retrieve information from the facility computer 121. Or, the facility computer 121 may automatically communicate received information to the appropriate airline 105.

In block 230, the facility computer 121 communicates data stored at the facility data storage unit 123 destined for one or more aircraft 140 to the vehicle computer 131 via the established wireless communication link. For example, the facility computer 121 may communicate in-flight entertainment content, software upgrades for on-board avionics computers, passenger lists, information regarding luggage aboard the aircrafts 140, and/or flight information for the aircrafts 140. Once received, the vehicle computer 131 stores the received data in the vehicle data storage unit 133.

In block 235, the vehicle wireless communication module 135 terminates the wireless communication link with the facility wireless communication module 125. Alternatively, the facility wireless communication module 125 terminates the wireless communication link with the vehicle wireless communication module 135. For example, the vehicle computer 131 may interact with the facility computer 121 to confirm that both computers 131, 121 have completed their respective data transmissions, and one of the computers 121, 131, can cause their respective wireless communication modules 125, 135 to terminate the wireless communication link.

In block 240, the operator moves the vehicle 130 from the facility 120. For example, in a catering truck embodiment, a catering truck operator may move the catering truck from the catering facility and towards an aircraft 140 after receiving food and drinks (and the date from the facility computer 121) for the aircraft 140.

FIG. 3 is a block flow diagram depicting a method 300 for transferring data between the vehicle 130 and the aircraft 140, in accordance with certain exemplary embodiments. The method 300 is described with reference to the components illustrated in FIG. 1.

In block 305, a vehicle operator navigates the vehicle 130 having the vehicle computer 131 to the aircraft 140. For example, the operator may drive a catering truck to a parked aircraft 140 to load food and drinks onto the aircraft 140. Once at the aircraft 140, the operator can cause a lifting box carrying the food and drinks to be lifted to the door of the aircraft 140. At this location, the vehicle antenna may have a line of sight with the aircraft antenna.

In block 310, the vehicle wireless module 135 detects the aircraft wireless module 145. In block 315, the vehicle wireless module 135 establishes a wireless communication link with the aircraft wireless module 145. This wireless communication link may be established automatically in response to the vehicle wireless communication module 135 detecting the aircraft wireless module 145. Alternatively, the aircraft wireless communication module 145 may detect the vehicle wireless communication module 135 and establish the wireless communication link in response thereto.

The vehicle computer 131 and the aircraft computer 141 may identify themselves to one another when the wireless communication link is initialized. For example, the vehicle computer 131 may transmit information identifying the vehicle 130 or the vehicle computer 131 to the aircraft computer 141 via the wireless communication link. Likewise, the aircraft computer 141 can transmit an aircraft identifier associated with the aircraft 140 to the vehicle computer 131 via the wireless communication link. The vehicle computer 131 can then use the aircraft identifier to determine what data should be transferred to the aircraft computer 141. For example, data associated with that aircraft identifier may be transferred to the aircraft 140 associated with the aircraft identifier only. The aircraft identifier and the information identifying the vehicle 130 also may be used for security purposes to ensure that each computer 131, 141 is communicating with an appropriate device.

In block 320, the vehicle computer 131 communicates data stored at the vehicle data storage unit 133 to the aircraft computer 141 via the established wireless communication link. For example, the vehicle computer 131 may communicate in-flight entertainment content, software upgrades for on-board avionics computers, a passenger list, information regarding luggage aboard the aircraft 140, and/or flight information to the aircraft 140. This information may have been obtained from the facility computer 121 while the vehicle 130 was located at the facility 120, as discussed above with reference to FIG. 2. Once the data is received, the aircraft computer 141 stores the received data at the aircraft data storage unit 143.

In block 325, the aircraft computer 141 communicates data stored at the aircraft data storage unit 143 to the vehicle computer via the established wireless communication link. For example, the aircraft computer 141 may communicate flight data, aircraft performance data, maintenance information, log files, including video log files, and in-flight entertainment usage and billing information to the vehicle computer 131 via the established wireless communication link. Once received, the vehicle computer 131 stores the received data at the vehicle data storage unit 133.

In block 330, the vehicle wireless communicate module 135 terminates the wireless communication link with the aircraft wireless communication module 145. Alternatively, the aircraft wireless communication module 145 terminates the wireless communication link with the vehicle wireless communication module 135. For example, the vehicle computer 131 may interact with the aircraft computer 141 to confirm that both computers 131, 141 have completed their respective data transmissions, and one of the computers 131, 141, can cause their respective wireless communication modules 135, 145 to terminate the wireless communication link.

In block 335, the operator moves the vehicle 130 from the aircraft 140. For example, a catering truck operator may move the catering truck from the aircraft and towards another aircraft 140 or back to the catering facility after loading food and drinks for the aircraft 140.

The exemplary methods and blocks described in the embodiments presented previously are illustrative, and, in alternative embodiments, certain blocks can be performed in a different order, in parallel with one another, omitted entirely, and/or combined between different exemplary methods, and/or certain additional blocks can be performed, without departing from the scope and spirit of the invention. Accordingly, such alternative embodiments are included in the invention described herein.

The invention can be used with computer hardware and software that performs the methods and processing functions described above. As will be appreciated by those having ordinary skill in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments of the invention have been described above in detail, the description is merely for purposes of illustration. Various modifications of, and equivalent blocks corresponding to, the disclosed aspects of the exemplary embodiments, in addition to those described above, can be made by those having ordinary skill in the art without departing from the spirit and scope of the invention defined in the following claims, the scope of which is to be accorded the broadest interpretation so as to encompass such modifications and equivalent structures.

What is claimed is:

1. A method for transferring data between a computer located on an aircraft and a computer located at a facility, comprising:
receiving data, from the computer located at the facility, at a computer located on a ground mobile vehicle, the data being received via a first wireless communication link between the computer located at the facility and the computer located on the vehicle;
moving the vehicle from a position near the facility to a position near the aircraft; and
transmitting the data from the computer located on the vehicle to the computer located on the aircraft via a second wireless communication link between the computer located on the vehicle and the computer located on the aircraft.

2. The method of claim 1, wherein the first wireless communication link and the second wireless communication link each comprise a 60 GHz wireless communication link.

3. The method of claim 1, wherein the first wireless communication link is automatically established in response to a wireless module communicably coupled to the computer located on the vehicle detecting a signal transmitted by a wireless module communicably coupled to the computer located at the facility when the vehicle is positioned near the facility.

4. The method of claim 1, wherein the second wireless communication link is automatically established in response to a wireless module communicably coupled to the computer located on the vehicle detecting a signal transmitted by a wireless module communicably coupled to the computer located on the aircraft when the vehicle is positioned near the aircraft.

5. The method of claim 1, wherein the data comprises at least one of in-flight entertainment content, a software upgrade for an on-board avionics computer, a passenger list, baggage information, and flight information.

6. The method of claim 1, further comprising:
receiving additional data at the computer located on the vehicle, from the computer located on the aircraft, via the second wireless communication link;
moving the vehicle from the position near the aircraft to the position near the facility; and
transmitting the additional data from the computer located on the vehicle to the computer located at the facility via the first wireless communication link.

7. The method of claim 6, wherein the additional data comprises at least one of aircraft performance data, maintenance data, a log file, in-flight entertainment usage information, and in-flight entertainment billing information.

8. The method of claim 1, wherein the vehicle comprises a catering truck and wherein the data is transmitted from the computer located on the vehicle to the computer located on the aircraft while the catering truck services the aircraft.

9. The method of claim 8, wherein the catering truck comprises a loading platform configured to be lifted to service the aircraft, and wherein the computer located on the vehicle is communicably coupled to a wireless module comprising an antenna mounted on the loading platform for providing a line of sight communication path with an antenna of a wireless module communicably coupled to the computer located on the aircraft.

10. A method for transferring data between a computer located on an aircraft and a computer located at a facility, comprising:
receiving data, from the computer located at the aircraft, at a computer located on a ground mobile vehicle, the data being received via a first wireless communication link between the computer located at the aircraft and the computer located on the vehicle;
moving the vehicle from a position near the aircraft to a position near the facility; and
transmitting the data from the computer located on the vehicle to the computer located at the facility via a second wireless communication link between the computer located on the vehicle and the computer located at the facility.

11. The method of claim 10, wherein the first wireless communication link and the second wireless communication link each comprise a 60 GHz wireless communication link.

12. The method of claim 10, wherein the first wireless communication link is automatically established in response to a wireless module communicably coupled to the computer located on the vehicle detecting a signal transmitted by a wireless module communicably coupled to the computer located on the aircraft when the vehicle is positioned near the aircraft.

13. The method of claim 10, wherein the second wireless communication link is established in response to a wireless module communicably coupled to the computer located on the vehicle detecting a signal transmitted by a wireless module communicably coupled to the computer located at the facility when the vehicle is positioned near the facility.

14. The method of claim 10, wherein the data comprises at least one of aircraft performance data, maintenance data, a log file, in-flight entertainment usage information, and in-flight entertainment billing information.

15. The method of claim 10, further comprising:
receiving additional data at the computer located on the vehicle, from the computer located at the facility, via the second wireless communication link;
moving the vehicle from the position near the facility to the position near the aircraft; and
transmitting the additional data from the computer located on the vehicle to the computer located on the aircraft via the first wireless communication link.

16. The method of claim 15, wherein the additional data comprises at least one of in-flight entertainment content, a software upgrade for an on-board avionics computer, a passenger list, baggage information, and flight information.

17. The method of claim 10, wherein the vehicle comprises a catering truck and wherein the data is transmitted from the computer located on the vehicle to the computer located on the aircraft while the catering truck services the aircraft.

18. The method of claim 17, wherein the catering truck comprises a loading platform configured to be lifted to service the aircraft, and wherein the computer located on the vehicle is communicably coupled to a wireless module comprising an antenna mounted on the loading platform for providing a line of sight communication path with an antenna of a wireless module communicably coupled to the computer located on the aircraft.

19. A system for transferring data, comprising:
a first computer located at an airport facility that stores data for one or more aircraft, the first computer being communicably coupled to a first wireless communication module; and
at least one vehicle comprising a second computer that transfers the data between the first computer and a third computer installed on each of the one or more aircraft, the second computer being communicably coupled to a second wireless communication module configured to exchange data with the first wireless communication module and to exchange data with a third wireless communication module communicably coupled to the third computer.

20. The system of claim 19, wherein the first computer is communicably coupled to a fourth computer via a network, the fourth computer being associated with an airline that provides at least a portion of the data for the one or more aircraft.

21. The system of claim 19, wherein the portion of the data comprises in-flight entertainment content.

22. The system of claim 19, wherein first wireless communication module, the second wireless communication module, and the third wireless communication module each communicate via a frequency band of approximately 60 GHz.

23. The system of claim 19, wherein the at least one vehicle navigates between the airport facility and the one or more aircraft to transfer the data between the first computer and the third computer.

24. The system of claim 19, wherein the second communication module of one of the at least one vehicle automatically establishes a wireless communication link with the first wireless communication in response to identifying the presence of the first wireless communication module when the one vehicle is positioned such that the second wireless communication module is in range to communicate with the first wireless communication module.

25. The system of claim 19, wherein the second communication module of one of the at least one vehicle automatically establishes a wireless communication link with the third wireless communication in response to identifying the presence of the third wireless communication module when the one vehicle is positioned such that the second wireless communication module is in range to communicate with the third wireless communication module.

26. The system of claim 19, wherein the at least one vehicle is associated with a facility that services aircraft between flights, and wherein the data is transferred from the second computer of one of the at least one vehicle to the third computer of one or the one or more aircraft while the one vehicle services the one aircraft.

27. The system of claim 26, wherein the at least one vehicle is associated with at least one of a catering facility, a fueling depot, and a baggage depot.

28. The system of claim 19, wherein the at least one vehicle comprises a loading platform that lifts to a door of the one or more aircraft, and wherein the second wireless communication module comprises an antenna installed on the loading platform to communicate with an antenna of the third wireless communication module installed proximal to the door via a line of sight communication path.
